(19) United States
(12) Patent Application Publication
(10) Pub. No.: US 2005/0092062 A1
(43) Pub. Date: May 5, 2005

(54) Device and method for determining the gas content of a liquid

(75) Inventors: Christian Beck, Burscheid (DE); Bolko Raffel, Dormagen (DE); Hubert Ehbing, Odenthal (DE); Peter Jahn, Leverkusen (DE); Franz Schmitt, Bergisch Gladbach (DE)

Correspondence Address: BAYER MATERIAL SCIENCE LLC, 100 BAYER ROAD, PITTSBURGH, PA, 15205, US

(73) Assignee: Bayer Aktiengesellschaft

(21) Appl. No.: 10/974,531

(22) Filed: Oct. 27, 2004

(30) Foreign Application Priority Data
Oct. 30, 2003 (DE) 10350757.4

(51) Int. Cl. G01N 7/00

(52) U.S. Cl. 73/19.05

(57) ABSTRACT

The invention describes a device for determining the gas content of a liquid. The device has at least a housing, a measuring chamber base with a cavity and a measuring chamber cover inside the housing. The measuring chamber base and the measuring chamber cover are each movable by a respective piston independently of one another along the longitudinal axis of the housing. The measuring chamber base and the measuring chamber cover form a measuring chamber in the housing. The measuring chamber base or the measuring chamber cover is connected to a pressure sensor and the housing has a liquid inlet and a liquid outlet.

### FIELD OF THE INVENTION

The invention relates to a device and a method for determining the gas content of a liquid.

### BACKGROUND OF THE INVENTION

In plastics processing technology, it is frequently necessary to determine the gas content of liquids, e.g. the gas content of liquid plastics components for producing foamed material; in order to be able to work with a constant and known gas content in continuous operation or in production. Numerous measuring devices for determining the gas content of liquids, in particular of liquid plastics components, are known in the art, e.g. DE-A 37 20 904, WO 99/02963. The known measuring devices generally use measuring cylinders provided with measuring pistons, into which cylinders a given sample quantity from the system conducting the gas-loaded liquid is introduced at intervals. This is generally carried out in such a way that the sample quantity loaded with the dissolved and, in some cases, free gas is subjected to negative pressure in the closed measuring cylinder chamber, the volume of the measuring cylinder chamber being increased by corresponding displacement of the piston. The gas in the sample quantity is thereby set free. The gas load of the liquid can be calculated from the measured changes in volume and pressure of the measuring sample using known physical relationships (gas law). A similar investigation is possible if the measuring sample is measured in the measuring cylinder by compression by means of the measuring piston and/or by a combination of decompression followed by compression, pressure being measured under the different test conditions and the volume of the measuring chamber being simultaneously determined at the different positions of the piston. In general, however, these methods cannot be used without difficulty in a fast-acting online measuring device, because either they cannot be operated in the through-flow using a bypass arrangement, and/or they are associated with considerable constructional complexity and cost. Furthermore, a relatively large sample quantity is necessary with the known measuring devices, resulting in a relatively long measuring time. The possibility of heating the sample is also frequently lacking, which also leads to a relatively long measuring time. Finally, with the known devices, cleaning steps are necessary between individual measurements. This makes continuous and cyclical measurement difficult or even impossible.

### SUMMARY OF THE INVENTION

Accordingly, the present invention obviates problems inherent in the art by providing a device and a method with which the gas content of liquids can be determined online and relatively rapidly. The device is constructed as simply as possible, i.e. the constructional cost is as low as possible.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 shows an embodiment of the inventive device in a longitudinal section;

FIG. 2 illustrates a portion of the inventive device according to FIG. 1 in which the measuring chamber cover and measuring chamber base are in contact; and

FIG. 3 shows a portion of the inventive device according to FIG. 1 in which the measuring chamber cover has been moved away to allow pressure measurement.

### DETAILED DESCRIPTION OF THE INVENTION

The present invention will now be described for purposes of illustration and not limitation. Except in the operating examples, or where otherwise indicated, all numbers expressing quantities, percentages and so forth in the specification are to be understood as being modified in all instances by the term “about.” The present invention is a device for determining the gas content of a liquid, containing a measuring chamber formed by a housing having a liquid inlet and a liquid outlet, an independently movable measuring chamber base having a cavity therein, the measuring chamber base attached to a first piston movable along a longitudinal axis of the housing and an independently movable measuring chamber cover attached to a second piston movable along the longitudinal axis of the housing, wherein at least one of the measuring chamber base and the measuring chamber cover is connected to a pressure sensor.

The device according to the invention is a double-piston system having a preferably cylindrical jacket. Both pistons are movable along the longitudinal axis of the preferably cylindrical housing. Both pistons are movable independently of one another, e.g. pneumatically via a throttle system. In operation, the device is preferably arranged vertically. Accordingly, the pistons are also referred to hereinafter as the lower (first) and upper (second) piston. A measuring chamber base is arranged at the upper end of the piston rod of the lower (first) piston. A measuring chamber cover is arranged at the lower end of the piston rod of the upper (second) piston. The space between the measuring chamber base and the measuring chamber cover forms the measuring space. The measuring chamber base has a cavity in its surface facing towards the measuring chamber cover. The measuring chamber cover or the measuring chamber base is connected to a pressure sensor. Preferably, the measuring chamber cover is connected to a pressure sensor. The measuring chamber base and/or the measuring chamber cover and/or the housing is/are connected to a heating source, e.g. a heating coil or a heating jacket. Preferably, the measuring chamber base is connected to a heating source.

Liquid flows into the housing through a liquid inlet and out of the housing through a liquid outlet. The liquid inlet and the liquid outlet may be arranged, for example, in alignment. They may also be arranged at any angle to one another and/or at different levels transversely to the longitudinal direction of the housing.

The cavity in the measuring chamber base serves to receive the liquid to be tested, which is supplied through the liquid inlet. The cavity in the measuring chamber base is so configured that the liquid to be tested forms a thin film. The dimensions of the cavity are distinguished by a ratio of volume to depth of 10⁶:1 to 1:1, preferably 10⁵:1 to 1:1. The geometrical shape of the cavity can be selected as desired. A cylindrical cavity is preferred.

The cross-sectional area of the cavity in the measuring chamber base may be of any desired size. Preferably, the cavity occupies the largest possible area of the measuring chamber base, so that the liquid to be tested forms the largest possible surface in the cavity when in operation. The cavity can occupy e.g. the entire area of the measuring chamber base, a narrow rim—for example, of the order of magnitude of a few millimeters—being present around the cavity. Thus, in a measuring chamber base having a diameter of 50 mm, for example, the cavity may have a diameter of 48 mm.

The surface of the cavity, i.e. the inner wall of the cavity, may be flat. To increase its surface area, however, the cavity may have a structured surface of knobs, corrugations or the like.

The present invention also provides a method for determining the gas content of a liquid using the device according to the invention involving moving the first and second piston to position the measuring chamber base and the measuring chamber cover for liquid to flow through the liquid inlet and the liquid outlet and for a sample to fill the cavity, moving the first piston so that the measuring chamber base contacts the measuring chamber cover and prevents liquid flow through the housing, evacuating the measuring chamber by moving the second piston to separate the measuring chamber cover and the measuring chamber base, measuring pressure in the measuring chamber with the pressure sensor and calculating the gas content of the sample, the sequence being executed at least once.

In the first step of the method according to the invention, the measuring chamber base and the measuring chamber cover are so positioned by the pistons that the liquid to be tested flows through the device. This means, firstly, that the measuring chamber base and the measuring chamber cover are maintained at a distance from one another, so that they form a measuring chamber in the housing. Secondly, the measuring chamber base and the measuring chamber cover are so positioned in the housing that the liquid inlet and outlet are located between them. In this way, the liquid to be tested can flow through the measuring chamber. The measuring chamber forms the zone of the device through which liquid flows. When liquid flows through the measuring chamber, the cavity in the measuring chamber base is also filled with liquid.

Next, a sample quantity is isolated by moving the lower (first) piston with the measuring chamber base upwards, i.e. in the direction of the upper (second) piston with the measuring chamber cover. The measuring chamber base is moved upwards until the opposed surfaces of the measuring chamber base and the measuring chamber cover are in contact and abut one another. As this happens liquid contained in the measuring chamber is displaced until only the quantity located in the cavity remains behind. In this way, the quantity of liquid to be tested is isolated in the cavity from the flow of liquid passing through the housing via the liquid inlet and outlet. For this reason, the cavity must be moved out of the zone of the liquid inlet and outlet, i.e. the through-flow zone, until it is located above the liquid inlet and the liquid outlet. This can be effected, for example, in that the lower (first) piston pushes the upper (second) piston out of the through-flow zone until the sample is separated from the through-flow zone of the device by the seals on the pistons and is ready for measurement.

Next, the measurement of the gas content of the quantity of liquid contained in the cavity is carried out. In order to generate negative pressure, the measuring chamber cover is moved upwards by the upper (second) piston, i.e. is moved away from the measuring chamber base. As this happens, a measuring chamber is again formed between the measuring chamber base and the measuring chamber cover. Because of the negative pressure, the gases contained in the liquid escape and components with low boiling points vaporize, until equilibrium vapor pressure is established in the measuring chamber. Vaporization may be assisted by a heating source connected to the measuring chamber base and/or the measuring chamber cover and/or the housing. The pressure in the measuring chamber is then measured. Measurement of the pressure by the pressure sensor, which is connected to the measuring chamber cover or the measuring chamber base, is carried out, for example, continuously during the movement of the piston as a function of piston travel. Alternatively, pressure measurement may be carried out at the end of the piston movement, i.e. at the end of the vaporization process. With the aid of the pressure measured in the measuring chamber the gas content of the sample, or the vapor pressure of the liquid, is calculated.

The movement of the upper (second) piston to generate the negative pressure in the measuring chamber preferably takes place in the range from 1 millisecond to 1 minute. In particular, the duration of the piston movement is in the range of milliseconds, especially preferably in the range from 0.1 to 4 seconds.

According to the present invention, the sequence of steps is executed at least once. The sequence may also be executed multiple times. After the pressure has been measured, the measuring chamber base and the measuring chamber cover can be moved back to the starting position by the pistons. As this happens, the sample quantity contained in the cavity is returned to the flow of liquid. The method according to the invention is therefore suitable for use as a cyclical method for continuous online measurement of the gas content of a liquid.

An advantage of the device according to the present invention is that it is comparatively simple, i.e. the technical complexity is relatively low. The sample is taken by the cavity. A valve system or a gravimetric system for metering the liquid to be sampled is not required. Because the device has no valves in contact with product, no malfunctions can occur as a result of blockage or leakage. The pistons may be driven pneumatically, so that servo motors are not required. In addition, the device operates without additional peripheral devices such as a circulation pump or vacuum pump. The device according to the invention requires neither a pump to make available an evacuated gas space nor a pump to supply the liquid to be tested to the measuring device. A defined vacuum in the measuring chamber is generated by a hydraulically driven piston movement.

A further advantage is the comparatively rapid measurement process. The duration of a measurement is as a rule not more than 5 minutes. The duration of a measuring cycle is preferably 1 to 5 minutes. The duration of a measuring cycle depends primarily on how rapidly the liquid to be tested vaporizes or how quickly the equilibrium pressure is established. Consequently, a measuring cycle may last more than 5 minutes. The rapid measurement is made possible by, among other factors, the rapid degassing of the liquid to be tested in the cavity, because the cavity forms a thin film of the sample liquid. In addition, the outgassing time can be further reduced by thermal and/or ultrasonic assistance.

Finally, the inventive device advantageously operates practically without product loss and without emissions, because the sample quantity is returned to the liquid flow after measurement. The device according to the invention is effectively self-cleaning, because the measuring chamber base and the measuring chamber cover are moved back to the starting position after measurement and liquid again flows through the measuring chamber. The following flow of liquid flushes the liquid sample of the previous measurement out of the measuring chamber. The seals on the measuring chamber base and the measuring chamber cover scrape off any drops of liquid adhering to the inner wall of the housing. Consequently, the liquid sample does not need to be removed from the measuring chamber by a separate process step before a new measurement can be carried out. Moreover, no additional cleaning step is necessary between two measurements.

The device according to the invention can be used, for example, for online measurement. Its use as a mobile hand-held appliance is also possible, e.g. for determining the gas load of liquid plastics components or the vapor pressures of liquids contained in storage reservoirs, for example.

If the device and method according to the present invention are to be used to determine the gas content of a flowing liquid, the measurement can be carried out without interrupting the flow, for example, by directing a part of the flow through a bypass to which the inventive device is connected.

The inventive device is suitable for determining, for example, the proportion of dissolved gases in a polyetherpolyol for manufacturing polyurethane foams. After the polymerization reaction of the educts, the gas content of the polyetherpolyol is determined using the device according to the invention. In doing so, the gas content is calculated from the equilibrium pressure, which is recorded by the pressure sensor, using, for example, the Ideal Gas Law.

In addition, the device according to the invention is suited to determining vapor pressures of liquids to test chemical purity, for example, during production.

It is likewise possible with the inventive device, in combination with an appropriate analysis device (IR spectrometer, Raman spectrometer or the like), to investigate the gas space qualitatively and quantitatively for its chemical composition.

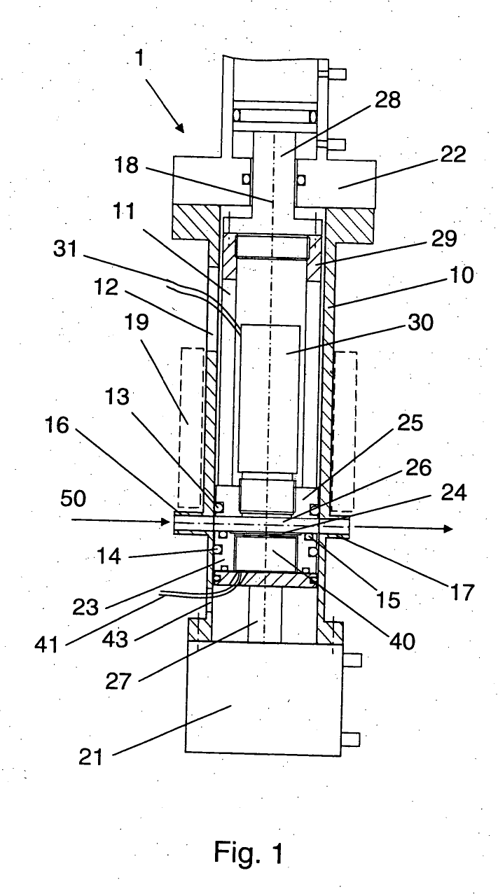

The inventive device 1 for determining the gas content of a liquid is illustrated in FIG. 1. It is made from a cylindrical housing 10 with a liquid inlet 16 and a liquid outlet 17, so that the liquid 50 to be measured can flow transversely through the housing 10, i.e. transversely to the longitudinal axis 18 (represented by a dot-dash line) of the housing 10. In the embodiment illustrated, the liquid inlet 16 and the liquid outlet 17 are arranged in alignment. Located above the liquid inlet 16 and the liquid outlet 17 is a measuring chamber cover 25, while a measuring chamber base 23 is located below the liquid inlet 16 and the liquid outlet 17. The measuring chamber base 23 has a cavity 24 in its upper surface, i.e. the surface facing towards the measuring chamber cover 25. In the embodiment illustrated, the cavity 24 has a depth of 1 mm and a diameter of 35 mm. The liquid flow 50 passing transversely through the housing 10 is therefore delimited upwardly by the measuring chamber cover 25 and downwardly by the measuring chamber base 23. The space between the measuring chamber cover 25 and the measuring chamber base 23 forms a measuring chamber 26. The measuring chamber cover 25 and the measuring chamber base 23 are sealed with respect to the housing 10 with elastic seals 13, 14, so that the liquid 50 flowing through the device is constantly renewed during operation, with a short dwell time and a narrow dwell time spectrum in the measuring chamber 26. A groove for receiving an elastic seal 15 is also provided around the cavity 24.

In the embodiment illustrated in FIG. 1, the measuring chamber cover 25 serves to accommodate a pressure sensor 30. The pressure sensor 30 and the lower surface of the measuring chamber cover 25, i.e. the surface facing towards the measuring chamber base 23, form a plane, so that product deposits and clearance volumes are avoided. The measuring chamber base 23 serves to accommodate a heating element 40. Provided in the lower portion of the housing 10 is an opening 43 through which, for example, the connecting cable 41 of the electrically heated heating element 40 can be connected to a power supply (not shown). In addition, an external heating element 19, e.g. in the form of a heating jacket, may be provided. An additional external heating element arranged around the housing 10 can accelerate vaporization and therefore the establishment of equilibrium.

The measuring chamber base 23 is fixed, e.g. detachably, to the piston rod 27 of the pneumatic piston 21. The measuring chamber cover 25 is connected, e.g. detachably, to the piston rod 28 of the pneumatic piston 22 via a distance piece 29. Longitudinal grooves or slots 11, 12 are provided in the distance piece 29 and in the housing 10 respectively, so that the cable 31 of the pressure sensor can pass outside to a data logger (not shown).

The positions of the measuring chamber cover 25 and the measuring chamber base 23 illustrated in FIG. 1 correspond to the starting position of the method according to the invention. The measuring chamber cover 25 is arranged above the liquid inlet 16 and the liquid outlet 17; the measuring chamber base 23 is arranged below the liquid inlet 16 and the liquid outlet 17. The liquid 50 to be tested flows through the measuring chamber 26 transversely through the housing 10. As the liquid flows through the device, the cavity 24 is constantly supplied with fresh liquid 50 taken from close to the process concerned.

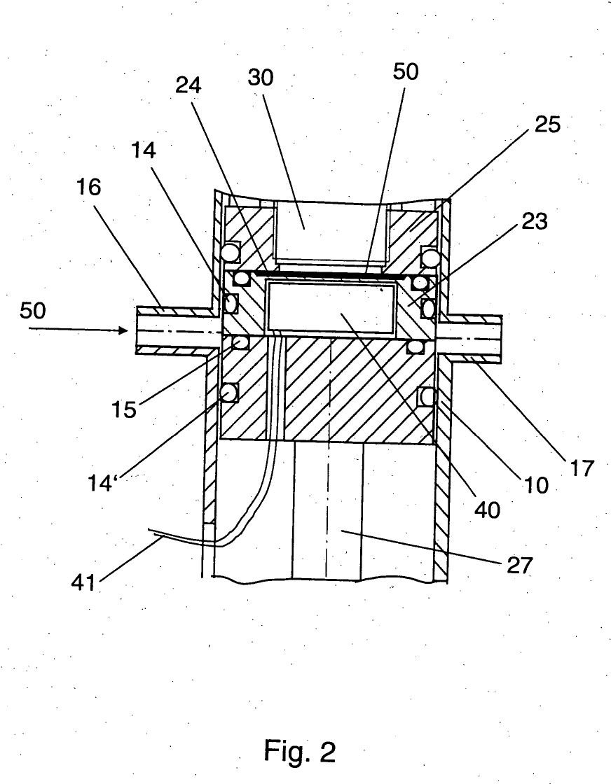

The position of the measuring chamber base 23 and the measuring chamber cover 25 in contact is shown in FIG. 2. The piston 21 (FIG. 1) moves the measuring chamber base 23 towards the measuring chamber cover 25, so that the two opposed surfaces contact one another. As this happens the surplus liquid 50 between these two faces is displaced, so that only the cavity 24 is filled with the liquid 50 to be tested. The filled cavity 24 is enclosed by the seal 15. The piston 21 moves the measuring chamber base 23 and the measuring chamber cover 25 with the piston 22 (FIG. 1) out of the zone of the liquid inlet 16 and the liquid outlet 17, so that, in the final position of the piston 21, the seal 14 of the measuring chamber base 23 is positioned above the liquid inlet 16 and the seal 14′ is positioned below the liquid inlet 16. The sample quantity in the cavity 24 is now completely separated from the flow of liquid 50.

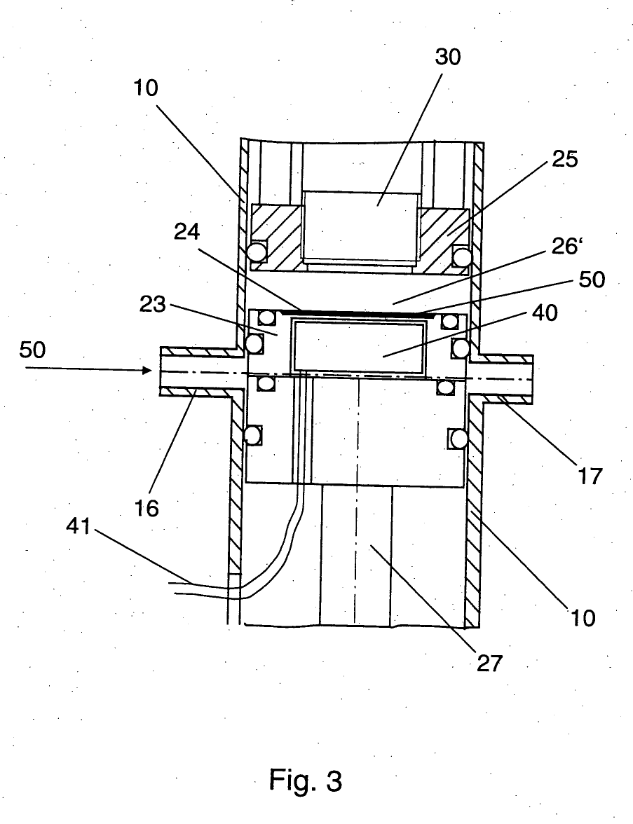

FIG. 3 shows the position of the measuring chamber base 23 and of the measuring chamber cover 25 during the pressure measurement. The piston 22 (FIG. 1) moves upwards and abolishes the surface contact between the measuring chamber base 23 and the measuring chamber cover 25, so that the measuring chamber 26′, which is evacuated, is formed between the two separated faces. Easily volatile components from the sample liquid 50 contained in the cavity 24 can now vaporize into the evacuated measuring chamber 26′. The upward movement of the measuring chamber cover 25 by the piston 22 takes place in milliseconds. An abrupt evacuation of the measuring chamber 26′ therefore occurs. During the vaporization of the easily volatile components or gases, the pressure in the measuring chamber 26′ changes. The pressure sensor 30 registers the pressure change, which approaches a limit value asymptotically. As soon as the limit value has been reached, the measurement is regarded as concluded and is terminated.

The cycle of the method according to the invention may now begin again, with the measuring chamber base 23 and the measuring chamber cover 25 being moved back to the starting position by the pistons 21, 22 respectively (FIG. 1). The measured sample quantity from the cavity 24 is displaced from the cavity 24 by the liquid 50 flowing through the device and is fed to the process. A new measurement of the vapor pressure with a fresh liquid sample can therefore take place.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A device for determining the gas content of a liquid comprising a measuring chamber formed by
a housing having a liquid inlet and a liquid outlet;
an independently movable measuring chamber base having a cavity therein, the measuring chamber base attached to a first piston movable along a longitudinal axis of the housing; and
an independently movable measuring chamber cover attached to a second piston movable along the longitudinal axis of the housing, wherein at least one of the measuring chamber base and the measuring chamber cover is connected to a pressure sensor.

2. The device according to claim 1 further including a heating source.

3. The device according to claim 2, wherein at least one of the housing, the measuring chamber base and the measuring chamber cover is attached to the heating source.

4. The device according to claim 1, wherein the cavity has a ratio of volume to depth of about 10⁶:1 to about 1:1.

5. The device according to claim 1, wherein the cavity has a ratio of volume to depth of about 10⁵:1 to about 1:1.

6. A method of determining the gas content of a liquid with a device comprising a measuring chamber formed by a housing having a liquid inlet and a liquid outlet, an independently movable measuring chamber base having a cavity therein, the measuring chamber base attached to a first piston movable along a longitudinal axis of the housing and an independently movable measuring chamber cover attached to a second piston movable along the longitudinal axis of the housing, wherein at least one of the measuring chamber base and the measuring chamber cover is connected to a pressure sensor, the method comprising:
moving the first and second piston to position the measuring chamber base and the measuring chamber cover for liquid to flow through the liquid inlet and the liquid outlet and for a sample to fill the cavity;
moving the first piston so that the measuring chamber base contacts the measuring chamber cover and prevents liquid flow through the housing;
evacuating the measuring chamber by moving the second piston to separate the measuring chamber cover and the measuring chamber base;
measuring pressure in the measuring chamber with the pressure sensor; and
calculating the gas content of the sample.

7. The method according to claim 6, wherein the step of evacuating occurs in about 1 millisecond to about 1 minute.

8. The method according to claim 6, wherein the step of evacuating occurs in about 0.1 to about 4 seconds.
